(19) United States
(12) Patent Application Publication
(10) Pub. No.: US 2014/0127367 A1
(43) Pub. Date: May 8, 2014

(54) MODULAR MOLD WITH CONNECTORS

(71) Applicants: Andrea Rae WOLF, New Albany, OH (US); Travis Rex Wolf, New Albany, OH (US)

(72) Inventors: Andrea Rae WOLF, New Albany, OH (US); Travis Rex Wolf, New Albany, OH (US)

(21) Appl. No.: 14/151,244

(22) Filed: Jan. 9, 2014

Related U.S. Application Data
(63) Continuation-in-part of application No. 13/135,475, filed on Jul. 7, 2011.

(51) Int. Cl. A23G 9/08

(52) U.S. Cl. CPC A23G 9/083
USPC 426/241; 249/97

(57) ABSTRACT

Modular mold unit and space-saving modular mold assembly, method, and article of manufacture for forming and preparing frozen confections that allow a quick release of the frozen confections from the mold by a microwave oven, wherein the mold unit is made of plasticizer-free, unadulterated, nonrecycled, heat-stable, microwave-transmissible plastic. The modular mold unit comprises a container member and a detachable lid member, wherein said container member comprises attachment means comprising vertically-engaging male and female lock-and-key mating or coupling connector members that are used to firmly and removably connect a plurality of modular mold units to one another to form an assembly of mold units, and wherein said detachable lid member has a stick member that is integrally molded with said lid member. Alternatively, said removable lid member is a stick-supporting lid having a central collar with a longitudinal slot opening to frictionally hold a separate wooden or plastic stick.

### CROSS-REFERENCE TO RELATED APPLICATION

This application is a continuation-in-part of application Ser. No. 13/135,475, filed on Jul. 7, 2011, the disclosure of which is incorporated herein by reference in its entirety.

### BACKGROUND OF THE INVENTION

This invention relates to a modular mold unit and space-saving modular mold assembly for forming and preparing a frozen confection, especially frozen confection on a stick, such as flavored ice and ice cream, that allow a quick release of the frozen confection from the mold by microwave radiation, said mold unit and mold assembly being made of plasticizer-free, unadulterated, nonrecycled, heat-stable, microwave-transmissible plastic. This invention also relates to a method using said mold unit and mold assembly to produce said frozen confection including the step of using microwave radiation for heating to quickly and conveniently release said confections from said mold.

The first popsicle is disclosed in U.S. Pat. No. 1,505,592 issued Aug. 19, 1924 to F. W. Epperson, which discloses a method for making frozen confections on a stick using test tubes to contain liquid syrup and a wooden stick. When the freezing operation is completed the container is immersed in luke warm water to loosen the frozen confection from the container to remove the confection from the container. A negative of such mold is such glass test tubes can be accidentally and easily broken or shattered.

Subsequently, there are other disclosures of mold assemblies for preparing frozen confections at home. U.S. Pat. No. 2,946,207 issued Jul. 26, 1960 discloses a mold assembly consisting of a plurality of individual cups integrally joined together with a web or sheet. Each cup has a lid or cap with a stick-like arm depending therefrom that is immersed in the liquid contained in the cup to support the resulting frozen article when the liquid is frozen in a freezer. Each cap also has a handle situated on the opposite side of the stick-like arm. The integral cups and web are made of resilient plastic material such as polyethylene, polypropylene, polystyrene, and polyvinyl chloride. No instructions are provided for how the frozen confections are to be released from the cups. The risk of the presence of plasticizer in the resilient plastic material is not appreciated.

U.S. Pat. No. 4,239,175 issued Dec. 16, 1980 discloses an improvement over U.S. Pat. No. 2,946,207, wherein each cap that serves to retain any molten liquid is provided with a straw member to allow the molten liquid therein to be drawn off The mold assembly is formed from a synthetic plastic material. No instructions are provided for how the frozen confections are to be released from the cups except a disclosure that the cap member can be lifted upwardly to remove the frozen product from the cup member. The risk of the presence of plasticizer in the resilient plastic material is not appreciated.

U.S. Pat. No. 5,354,191 issued Oct. 11, 1994 discloses a variation from U.S. Pat. No. 4,239,175, with the mold assembly comprising a planar tray member wherein the cups can either be integral parts of the tray member or be removably mounted in the openings of the tray member, and wherein the caps (or covers) of the cups also include passageway arrangement to draw off any melted liquid. The mold assembly can be made from any suitable synthetic plastic materials. For consumption, the cover and holder assemblies can each be removed with the frozen food product from its associated container by heating, such as applying hot water to the outer surface of the container.

In the hereinabove U.S. Pat. Nos. 2,946,207, 4,239,175, and 5,354,191, there is no anticipation of heating by microwave radiation nor indication of concern of a potential of leaching or migrating of toxic plasticizers from the plastic to the comestible confection, especially upon heating, especially heating under microwave radiation, nor a potential of degradation of plastic that can result upon heating, especially heating under microwave radiation, to form toxic by-product ingredients that would contaminate the comestible confection.

U.S. Pat. No. 3,411,463 issued Nov. 19, 1968 discloses a mold assembly comprising a rigid plastic tray having openings to hold a series of metallic cups, each cup is covered by a flexible stick-supporting cap having a slot that is centrally located to frictionally hold a wooden stick. The flexibility of the plastic cap allows it to be snapped to the rim of the cup. The cups are filled with confection liquid then inserted in the openings of the tray, and the whole assembly is placed in the freezer compartment of a home refrigerator to be frozen. It is disclosed that the frozen comestible can be separated from its cup by subjecting the latter for a short period of time to the heat of a human hand. The metallic cups do not contain plasticizer but they are not microwave-transmissible to allow heating by microwave.

U.S. Pat. No. 6,301,919 issued Oct. 16, 2001 discloses a machine that can be used by children to make ice cream bars on a stick wherein the machine includes metal containers to receive and hold ice cream bar mix.

Homemade ice cream bars or popsicles are frozen in the freezer compartment of a home refrigerator, and the frozen bars are extracted from the molds by warming the outside of the molds to melt the interface of the frozen bars and molds then pulled from the molds using the inserted sticks. The common method for warming the molds is to place them upside down or sideways under a stream of hot or warm tap water. A commercially available mold assembly that comprises eight cups integrally joined together with a plate that is produced by Arrow Plastic Manufacturing Co., Elk Grove, Ill. 60007, has the following instructions: “Fill to just below top. Insert sticks and place in freezer. To remove, run water on outside of pops.” This heating method is not efficient because the water flow and coverage are not uniform, thus the hot water is not applied uniformly. Furthermore, the walls of the plastic molds are heat-insulating, so that it usually takes some time to thaw the surface of the frozen bars. Also, the water flow is not easily controlled, such that water spilling into the inside of the molds to contaminate the comestible bars can occur.

Integral trays disclosed in the above U.S. Pat. Nos. 2,946,207 and 4,239,175, and the mold assembly that is provided by the Arrow Plastic Manufacturing Co. do not allow the flexibility of making the exact number of frozen confections that are needed, and thus they can undesirably occupy more room in the freezer compartment than needed. For example, using a tray with eight cups to make four frozen confection units leaves four empty cups that take extra room. To make ten frozen confection units required two trays with even more room that is wasted. Even the mold assemblies with individual cups that are disclosed in U.S. Pat. Nos. 3,411,463 and 5,354,191 can unnecessarily take extra room in the freezer compartment, because the tray requires the full space even when less than maximum number of individual cups are used with the tray.

It is therefore an object of the present invention to provide an improved space-saving modular mold unit and mold assembly that allow the preparation of an exact number of frozen confections that are needed without taking extra space in the freezer compartment of a home refrigerator.

It is also an object of the present invention to provide an improved mold for forming and preparing frozen confections that allows heating in a microwave oven for a quick and convenient release of the frozen confections that also avoids the step of releasing the confections by hot running water that is inconvenient and may contaminate the frozen confections.

Other objects and advantages will become apparent and understood by reference to the following detailed description of the preferred embodiments that follows.

### SUMMARY OF THE INVENTION

The present invention relates to a modular mold unit and space-saving modular mold assembly for making frozen confections, wherein each said modular mold unit comprises a container member and a removable and reclosable lid member, wherein said container member comprises attachment means comprising two or four mating or coupling connector members that are used to firmly and removably connect a plurality of said modular mold units to one another to form an assembly of mold units, wherein said mold assembly allows the preparation of an exact number of frozen confections on a stick that are needed without causing extra dead space in the freezer compartment of a home refrigerator.

The mating or coupling connector members can include vertical coupling connector members which are configured for coupling by a vertically-directed insertion. The four vertical coupling connector members can comprise two vertical female connectors and two vertical male connectors that operatively connect to the female coupling connector members by a vertical insertion. The vertical female connectors can have a vertically elongated channel of substantially constant horizontal cross section. The vertical male connectors can include a vertically elongated head of substantially constant horizontal cross section. The head extends from an exterior side surface of the container member by a neck which extends thorough a slot in the vertical female connectors. The vertically elongated head is configured to slidingly enter and frictionally engage the elongated channel. Typically the sectional shape of the head portion and its counterpart channel portion are oval.

The container member of the modular mold unit comprises an opening on the top side, wherein said opening is covered by a removable lid member, wherein said lid member comprises a raised ridge that fits snuggly with said opening, and said lid member further comprises an interior stick-like anchor to support the frozen confection and an exterior handle, wherein said interior stick-like anchor and said exterior handle are integrally molded to said lid.

This invention also relates to modular mold units and mold assembly for forming and preparing frozen confections on a stick, that allow a quick release of the frozen confections by microwave radiation, said mold units being made of plasticizer-free, unadulterated, nonrecycled, heat-stable, microwave-transmissible plastic.

In another embodiment of the present invention, the removable lid member is a stick-supporting lid having a central collar with a longitudinal slot that is centrally located in said lid to frictionally hold and support a wooden or plastic stick and divides said stick into a handle and an anchor, and wherein said lid member is optionally made of semi-rigid silicone rubber.

This invention also relates to a method of producing frozen confections, such as flavored ice and ice cream, including the step of placing liquid confection material in the receptacles of the modular mold units of the mold assembly, with said mold units and mold assembly being made of plasticizer-free, nonrecycled, heat-stable, microwave-transmissible plastic, placing the molds in a freezer compartment to freeze the liquid, and using microwave radiation to quickly and conveniently release said frozen confections from said molds. The modular mold units can include vertical male and female coupling connectors that can be connected together to one another using the respective vertical female and vertical male coupling connector members to form the assembly of mold units, employing a vertical insertion of the male connectors into the female components. Selected individual mold units of the assembly of mold units containing the frozen confections can be disconnected or unhooked from the remaining mold units, and setting aside the desired number of mold units containing the frozen confections for immediate consumption.

The heating in the microwave oven is performed for a required heating time selected from the group consisting of at least about 2 seconds, at least about 4 seconds, at least about 5 seconds, up to about 20 seconds, up to about 15 seconds, up to about 10 seconds, and combinations thereof.

This invention also relates to an article of manufacture that provides frozen confection modular mold units as described above, and that optionally provides other parts such as wooden or plastic sticks, and instructions for use; and wherein such modular molds can carry an indicia that, e.g., either identifies the molds, describes their convenient use, etc. It is important to provide instructions that indicate that the molds can safely be used in a microwave oven for quickly, conveniently, and hygienically releasing the confections from the molds, to provide the user with an appropriate incentive for using the invention.

In this document, the term “about” is presumed to modify all numerical values, it being understood that exact numerical values are not required unless it is specifically stated.

### BRIEF DESCRIPTION OF THE DRAWINGS

FIG. 1 is an exploded perspective view of an embodiment of a modular mold unit of the present invention, comprising a container member and a removable lid member, wherein the container member has two female connector members on two consecutive faces and two mating male connector members on the two remaining consecutive faces, and wherein the removable lid member comprises a lid body with a stick-like arm and a handle situated on the opposite side of the stick-like arm, wherein the stick-like arm and the hand are integrally molded to the lid member;

FIG. 2 is a cross-sectional view of the removable lid member of FIG. 1 showing the broad side view of the lid member, taken along line 2-2 of FIG. 1;

FIG. 3 is a cross-sectional view of the removable lid member of FIG. 1 showing the narrow side view of the lid, taken along line 3-3 of FIG. 1;

FIG. 4 is the overhead view of the container member of FIG. 1; showing the oval top side, two consecutive female connector members, and two consecutive male connector members;

FIG. 5 is an overhead view of an assembly of four modular mold units of FIG. 1 wherein the modular mold units are firmly held to one another by female coupling connector members attached to male connector members;

FIG. 6 is an exploded perspective view of another embodiment of a modular mold unit of the present invention, comprising a tapered circular cylindrical container member and a removable lid member, wherein the container member comprises a round top side, and two female mating connector members and two male mating connector members at the upper portion of the container, and wherein the removable lid member has a lid body comprising a central collar with a longitudinal slot to hold a wooden or plastic stick, with one end of the stick serving as an anchor to hold the frozen confection and the other end serving as a handle;

FIG. 7 is a cross-sectional view of the removable lid member of FIG. 6 showing the broad view of said lid member taken along line 7-7 of FIG. 6, wherein said lid member comprises the central collar with the longitudinal slot holding the stick; and

FIG. 8 is an overhead view of the container member of the modular mold unit of FIG. 6 showing the two female mating connector members and two male mating connector members integrally molded to the round top side of the circular top side. The cavity reveals the inner side of the circular bottom side, and the inner side of the outer tapered circular cylindrical side.

FIG. 9 shows a pair of modular mold units connected through vertical female and male coupling connector members, in the process of being unhooked or disconnected.

These drawings are not drawn to scale and are intended for illustrative purposes only.

### DETAILED DESCRIPTION OF THE INVENTION

The present invention relates to a modular mold unit and a space-saving modular mold assembly for forming and preparing frozen confections, said mold unit and mold assembly allow the preparation of an exact number of frozen confections on a stick that are needed without taking any extra space in the freezer compartment of the home refrigerator. Preferably said mold and mold assembly allow a quick release of the frozen confections from the mold by microwave radiation, preferably a home microwave oven, wherein said mold is made of microwave-safe plastic comprising plasticizer-free, unadulterated, nonrecycled, heat-stable, microwave-transmissible plastic.

“Modular mold unit,” as used herein, means that each individual mold unit comprises a container member or cup having attachment means, comprising two or four lock-and-key mating or coupling connector members, that are used to firmly and removably connect a plurality of modular mold units to one another to form an assembly of mold units, wherein each said modular mold has an opening on the top side covered by a removable lid member or cap, and wherein said modular mold is not part of a mold assembly that is either (a) integrally joined together with a tray (or a web or sheet) that has fixed and predetermined dimensions, such as those that are disclosed in U.S. Pat. No. 2,946,207 issued Jul. 26, 1960 to Hulterstrum, U.S. Pat. No. 4,239,175 issued Dec. 16, 1980 to Straubinger, and U.S. Pat. No. 5,354,191 issued Oct. 11, 1994 to Bobis, all said patent are incorporated herein by reference, or (b) a part of a mold assembly wherein said mold assembly comprises a flat rigid plastic tray (or top) with spaced feet for supporting said tray and having fixed and predetermined dimensions and having openings to hold a plurality of said mold, such as those that are disclosed in U.S. Pat. No. 3,411,463 issued Nov. 19, 1968 to Moseres, and U.S. Pat. No. 5,354,191 issued Oct. 11, 1994 to Bobis, all said patent are incorporated herein by reference. “Microwave-safe plastic,” as used herein, means plasticizer-free, unadulterated, nonrecycled, heat-stable, microwave-transmissible plastic. “Plasticizer free,” as used herein, means that the plastic material used in the present invention does not contain plasticizers, which are additives to plastics to make them more flexible. Plasticizers can be harmful to the health, even carcinogenic, when consumed, even at low levels. Plasticizers are not bound to plastics and can migrate out of plastic, especially by heating, more especially by heating by microwave which is essential for the method of heating of the present invention, and contaminate the confection to be consumed. “Unadulterated,” as used herein, means that the plastic material used in the present invention is not blended with other types of plastics or recycled plastics. “Nonrecycled,” as used herein, means that the plastic used in the present invention does not contain any recycled plastic, which is plastic material that had been used before and is recycled and blended with new plastic. Recycled plastic is mixtures of prior used plastics that are collected from many sources, some of which can contain plasticizers. “Heat-stable,” as used herein, means that the plastic used in the present invention is not degraded by heat. Polymers such as polystyrene and polycarbonate are generally not heat stable and also contain bisphenol A. Polyvinyl chloride plastic normally contains phthalate plasticizer and bisphenol A. “Microwave transmissible,” as used herein, means that the material allows a substantial amount of microwave radiation to pass through. Plastic materials normally are microwave-transmissible except when they are embedded with metallic materials. Metallic molds are generally not microwave-transmissible. Preferred plastic material for use in the present invention include plasticizer-free, unadulterated, and nonrecycled polyethylene terephthalate (polyester), plasticizer-free, unadulterated, and nonrecycled polypropylene, plasticizer-free, unadulterated, and nonrecycled high density polyethylene, plasticizer-free, unadulterated, and nonrecycled low density polyethylene, and semi-rigid silicone rubber. Due to its flexible nature even without containing plasticizer, the semi-rigid silicone rubber is a preferred material to make the lid of the individual mold. For the purpose of this invention, molds made with glass, rubber, latex, or metal are not preferred. Polyvinyl chloride, polystyrene, and polycarbonate should be avoided.

The consumer has endured for many years the problems of inconvenient removal of frozen confections by the use of running water and of the space requirement to store half empty mold assembly in the freezer. It is surprising that heating by microwave radiation still can preserve the integrity of the frozen confection bars, and this novel heating method for releasing frozen confection bars has provided more convenience and safety in the preparation of frozen confections for home consumption.

Thus this present invention relates to a modular mold unit for making frozen confection comprising a container member (or cup) and a removable (or detachable) lid member (or cap), wherein said container member comprises a receptacle with an opening on the top side to receive and hold a flavored liquid syrup to be frozen, and attachment means comprising and two or four lock-and key connector members on the body side, wherein said connector members are used to firmly and removably connect a plurality of said modular mold units to one another to form an assembly of mold units, wherein said mold assembly allows the preparation of an exact number of frozen confections on a stick that are needed without causing extra dead space in the freezer compartment of a home refrigerator, wherein said opening on the top side of said modular unit is covered by said removable lid member, wherein said lid member comprises a raised ridge that fits snuggly over said opening of the container member, an interior stick-like anchor (or arm) depending from said lid member to support the frozen confection, and an exterior handle-like arm situated on the opposite side of the stick-like anchor from the lid member, said anchor and said arm are integrally molded to said lid member, and wherein said container member and said lid member are made of plasticizer-free, unadulterated, nonrecycled, heat-stable, microwave-transmissible plastic. Alternatively, said removable lid member is a stick-supporting lid having a central collar with a longitudinal slot that is centrally located in said lid to frictionally hold a separate elongated wooden or plastic stick, preferably a stick with round ends, and to divide said stick into a handle and an anchor, and wherein said plastic stick is made of microwave-safe plastic comprising plasticizer-free, unadulterated, nonrecycled, heat-stable, microwave-transmissible plastic, and wherein said lid member is optionally made of semi-rigid silicone rubber.

Non-limiting examples of lock-and-key coupling connector members that are suitable for use as attachment means to form a mold assembly of the present invention include mating loop and hook VELCRO®-type strips, multiple rib and groove ZIPLOCK®-like strips, stud and cavity LEGO®-type plates, or female and male coupling connector members. Female and male coupling connector members are the preferred coupling connector members. The coupling connector members are attached to the sides of the container members of the modular mold units, and allow the mold units to be firmly linked to one another to form a one-dimension (or one-direction) or a two-dimension (or two-direction) mold assembly. The mold assembly of the present invention allows the preparation of an exact number of frozen confections that are needed without taking extra space in the freezer compartment of a home refrigerator. Furthermore, this mold assembly allows the removal and heating of only the exact number of confection units that are needed. The number of unused frozen confections in the intact modular mold units can be re-stored in the freezer compartment with a reduced volume.

In one embodiment of the present invention, the modular mold unit comprises a tapered ovoid cylindrical container member and a removable lid member. The container member comprises a tapered ovoid cylindrical receptacle body with two opposing broad side aspects and two opposing narrow side aspects, an oval bottom side, and an oval top side comprising a rim with an outer edge and an inner edge, wherein said inner edge delineates the opening of cavity that receives and holds the liquid syrup to be frozen. Two vertical female coupling connector members are integrally molded to the two proximal aspects of the receptacle, while two vertical male coupling connector members are integrally molded to the other two proximal aspects. The vertical female connector members and male connector members are positioned at the upper portion of the side of the container and are used to firmly and removably connect a plurality of modular mold units to one another to form a one-dimension or a two-dimension assembly of mold units that, when the receptacles are charged with liquid syrup, is placed in a freezer compartment to produce frozen confections. The removable lid member comprises the lid body with an oval edge that fits with the outside edges of rim of the container. At its bottom side, the lid member has a raised ridge that fits snuggly with the inside edge of the rim of the container member. Integrally molded to the lid body are an interior elongated stick member (or anchor) and an exterior elongated member (or handle). The interior anchor which can be flat or have indentations or transverse ridges must be sufficiently long to enable the frozen confection to be formed thereon and also have sufficient strength to hold a frozen confection while it is being consumed. The exterior handle, which can be flat or other configurations (such as having indentations or transverse ridges), enables the consumer to grip and hold the lid member with the frozen confection thereon while the frozen confection is being consumed. The modular mold unit is made using plasticizer-free, unadulterated, nonrecycled, heat-stable, microwave-transmissible plastic to allow convenient heating in a microwave oven for a quick release of the frozen confections from the mold. The detachable lid member can alternatively be a stick-supporting lid, wherein the lid body comprises a central collar having a longitudinal slot that frictionally holds a separate elongated flat stick, preferably a stick with round ends, and divides said stick into an exterior portion serving as the handle and an interior portion serving as the anchor to hold the frozen confection. The stick can be made of wood or molded microwave safe plastic. The lid member is made of microwave safe plastic, preferably of semi-rigid silicone rubber, that allows it to fit closely to the rim of the opening of the container member. The preferred lid that is made of semi-rigid silicone rubber can also better enable the vertical slot opening of the central collar to grip the inserted stick and allows a snuggly fitting of the stick into the slot opening.

In another embodiment of the present invention, the modular mold unit comprises a tapered circular cylindrical container member and a round removable lid member. The container member comprises a tapered circular cylindrical receptacle, with a tapered circular cylindrical side, a round bottom side, and a round top side comprising a circular rim with an outer edge and an inner edge. Two vertical female coupling connector members and two vertical male coupling connector members are consecutively molded at equidistance around the outer edge of the receptacle. The coupling connector members are used to firmly and removably connect a plurality of modular mold units together to form a one-dimension or two-dimension assembly of mold units. The container member of the modular mold unit is preferably made of plasticizer-free, unadulterated, nonrecycled, heat-stable, microwave-transmissible plastic to allow convenient heating in a microwave oven for a quick release of the frozen confections from the mold.

The present invention also relates to a mold assembly comprising a plurality of modular mold units that are firmly attached to one another by the attachment means to form a one-dimension or two-dimension assembly of mold units.

The present invention also relates to an article of manufacture comprising the mold assembly described hereinabove, optionally a plurality of wooden or plastic sticks, and optionally instructions for use.

The instructions for use provide information including one or more of: the molds can be used to save space in the freezer compartment; the molds can be safely used in a microwave oven for quickly, conveniently, and hygienically releasing the confections from the molds; and/or the way to determine the length of time needed to heat the mold units in a microwave oven; wherein said instructions for use are printed on one or more of: the package; the accompanying instruction flyer; and/or communicated via print and/or electronic mass media: newspapers, magazines, radio, television, internet, circulars, and the like, and wherein said instructions can be in words, or illustrative images and/or icons including in combination with words.

The present invention also relates to a method for producing of frozen confections that allows the preparation of an exact number of frozen confections on a stick that are needed without causing extra dead space in the freezer compartment of a home refrigerator, and that allows a quick, hygienic, and convenient release of the frozen confections by a microwave oven, said method includes the steps of:
(1) providing a plurality of modular mold units described herein above, wherein each said mold unit comprises a removable lid member comprising either an interior stick-like anchor and an exterior handle which are integrally molded to said lid; or a central collar with a longitudinal slot that is centrally located in said lid to frictionally hold and support a separate wooden or plastic stick and to divide said stick into a handle and an anchor;
(2) hooking the desired number of modular mold units to one another using the lock- and key attachment means to form an assembly of mold units;
(3) inserting and securing a flat plastic or wooden stick into the slot opening of the central collar of each lid member if the lid provides said slot opening, and dividing said stick into a handle and an anchor,
(4) placing liquid confection material into the receptacles of the mold units;
(5) snuggly fitting the lids over the openings of the receptacles;
(6) placing the assembly of filled mold units into a freezer and waiting until the liquid confection material is frozen;
(7) removing the assembly of mold units containing the frozen confections from the freezer, unhooking and setting aside the desired number of mold units containing the frozen confections for immediate consumption;
(8) returning the smaller assembly of unused units to the freezer compartment; and
(9) heating the frozen confections in the set-aside molds using a microwave oven to quickly and conveniently thaw the outer layer of the frozen confections to release said frozen confections from the molds.

The heating time needed to heat the mold units in the microwave oven to release and remove the frozen confections varies depending on the power of the microwave oven and on the number of frozen confections that are in the molds depends on the power of the microwave oven and the size of the frozen bars. Normally the required heating time for each individual mold unit is in the range of from at least about 2 seconds, at least about 4 seconds, at least about 5 seconds and up to about 20 seconds, up to about 15 seconds, up to about 10 seconds. Heating several mold units at the same time requires the multiple or slightly less of the individual heating times. When using the article of manufacture of the present invention for the first time, a consumer may need to determine the heating time that is appropriate with his or her particular microwave oven.

Some embodiments of the invention will now be described by way of example hereinafter with reference to the drawings. Similar reference numbers denote corresponding features throughout the drawings. The elements of one embodiment can be combined with those of other elements, or can be used alone.

Those skills in the art will recognize that other forms of this general type of molds can be used without departing from the scope of the present invention.

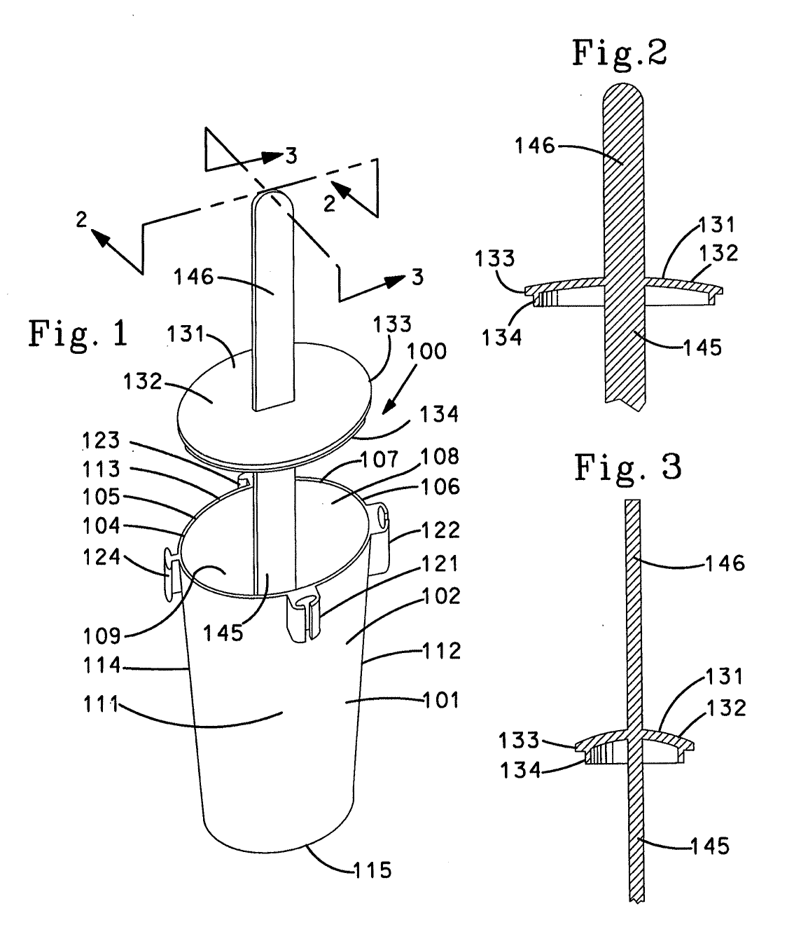

FIG. 1 is an exploded perspective view of an embodiment of a modular mold unit of the present invention, said modular mold unit 100 comprises the container member 101 and a removable lid member 131. The container member 101 comprises a tapered ovoid cylindrical receptacle 102 with two opposing broad exterior body side aspects 111 and 113, and two opposing narrow exterior body side aspects 112 and 114, an oval bottom side 115, and an oval top side 104 comprising rim 105 with outer edge 106 and inner edge 107, wherein said inner edge 107 delineates the opening 108 of cavity 109 that receives and holds the liquid syrup to be frozen. Two vertical female coupling connector members 121 and 122 are integrally molded to the two proximal aspects 111 and 112, while two vertical male coupling connector members 123 and 124 are integrally molded to the two proximal aspects 113 and 114. The vertical female connector members 121 and 122 and male connector members 123 and 124 are positioned at the upper portion of receptacle 102 and are used by the lock-and-key mechanism to firmly and removably connect a plurality of modular mold units 102 together to form an assembly of mold units that is placed into a freezer compartment to produce frozen confections, when the receptacles are charged with flavored liquid syrup. The removable lid member 131 comprises the lid body 132 with an oval edge 133 that fits with the outer edge 106 of rim 105 of the container 101 at the oval top side 104. At its bottom side, lid member 131 has the raised ridge 134 that fits snuggly with the inside edge 107 of rim 105 of container member 101. Integrally molded to the lid body 132 are an interior elongated stick member (or interior anchor) 145 and an exterior elongated handle member 146. The interior anchor 145 which can be flat (as shown) or have indentations or transverse ridges (not shown) must be sufficiently long to enable the frozen confection to be formed thereon and also have sufficient strength to hold a frozen confection while it is being consumed. The exterior handle 146, which can be flat (as shown) or other configurations (such as having indentations or transverse ridges, not shown), enables the consumer to grip and hold the lid member 131 with the frozen confection thereon while the frozen confection is being consumed. Preferably the modular mold unit is made of plasticizer-free, unadulterated, nonrecycled, heat-stable, microwave-transmissible plastic to allow convenient heating in a microwave oven for a quick and convenient release of the frozen confections from the mold.

FIG. 2 is a cross-sectional view of the removable lid member 131 of FIG. 1 showing the broad side view of the lid, taken along line 2-2 of FIG. 1, with the lid body 132 having edge 133 and ridge 134, and wherein the interior anchor 145 and exterior handle 146 are integrally molded to lid body 132.

FIG. 3 is a cross-sectional view of the removable lid member 131 of FIG. 1 showing the narrow side view of the lid, taken along line 3-3 of FIG. 1, with the lid body 132 having edge 133 and ridge 134, and wherein the interior anchor 145 and exterior handle 146 are integrally molded to lid body 132.

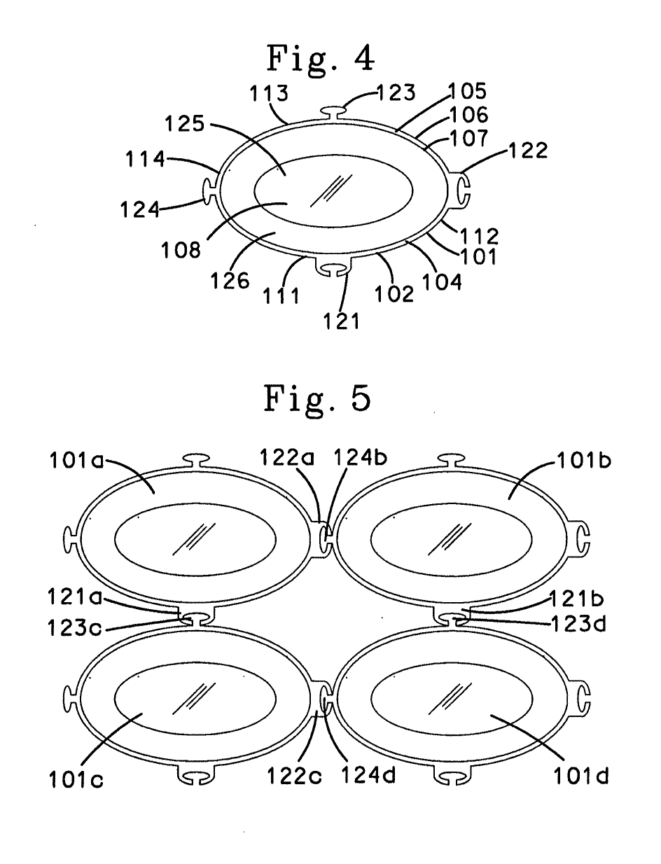

FIG. 4 is an overhead view of the container member 101 of the modular mold unit of FIG. 1 showing the oval top side 104 comprising oval rim 105 with outer edge 106 and inner edge 107, and with the lid member 131 being removed. The cavity 109 reveals the oval inner bottom side 125 of the oval exterior bottom side 115 (not shown), and the inner body side 126 of the tapered oval cylindrical receptacle 102. Also shown are female coupling connector members 121 and 122, and male coupling connector members 123 and 124, which are molded to aspects 111, 112, 113, and 114, respectively.

FIG. 5 is an overhead view of an assembly of a plurality of modular mold units of FIG. 1 wherein the modular mold units (four units in this case, from 101a through 101d) are firmly held together by female coupling connector members 121 to male connector members 123 and female connector members 122 to male connector members 124.

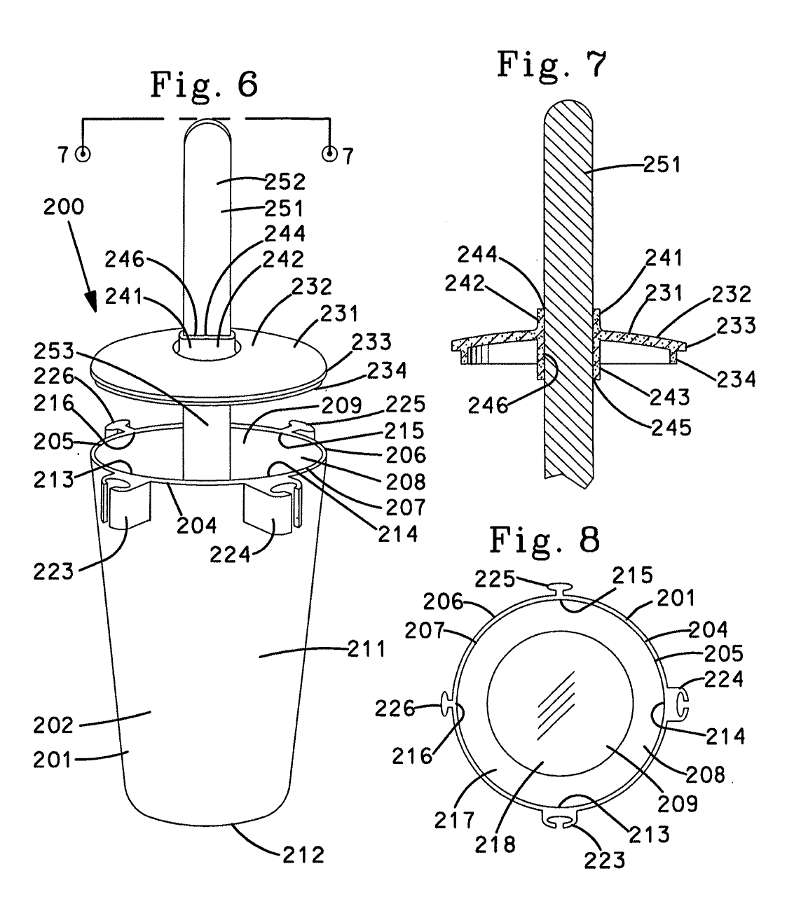

FIG. 6 is an exploded perspective view of another embodiment of a modular mold unit of the present invention, said modular mold unit 200 comprises the container member 201 and a removable lid member 231. The container member 201 comprises a tapered circular cylindrical receptacle 202 with exterior body side 211, a round exterior bottom side 212, and a round top side 204 comprising rim 205 with outer edge 206 and inner edge 207, wherein said inner edge 207 delineates the opening 208 of cavity 209 that receives and holds the liquid syrup to be frozen. The outer edge 206 is marked by four points 213, 214, 215, and 216, said four points 213, 214, 215, and 216 are equidistant around the outer edge 206 (with arc 213-214, 214-215, 215-216, and 216-213 all being equal). Two vertical female mating connector members 223 and 224 are integrally molded to the top side 204 at two proximal points 213 and 214, and two vertical male mating connector members 225 and 226 are integrally molded to the two proximal points 215 and 216 The vertical female connector members 223 and 224 and male connector members 225 and 226 are thus positioned at equidistance around the upper portion of the exterior body side 211 of receptacle 202 and are used to firmly and removably connect a plurality of modular mold units 200 together to form an assembly of mold units that is placed in a freezer compartment to produce frozen confections, when the receptacles are charged with flavored liquid syrup. Preferably the container member 201 of the modular mold unit 200 is made of plasticizer-free, unadulterated, nonrecycled, heat-stable, microwave-transmissible plastic to allow convenient heating in a microwave oven for a quick and convenient release of the frozen confections from the mold. The detachable lid member 231 comprises the lid body 232 with edge 233 that fits with the outer edges 206 of rim 205 of the top side 204 of container 201.

At its bottom side, lid member 231 has the raised circular ridge 234 (inferior to edge 233) that fits snuggly with the inside edge 207 of rim 205 of container 201. Situated centrally on lid 231 is a central collar 241 comprising the exterior portion 242 with opening 244 and interior portion 243 (not shown) with opening 245 (not shown), wherein opening 244 and opening 245 are parts of the longitudinal slot 246 which holds a separate elongated flat stick 251 that comprises an exterior portion 252 serving as the handle and an interior portion 253 serving as the anchor to hold a frozen confection. Stick 251 can be made of wood or molded microwave safe plastic. Lid 231 is preferably made of microwave safe plastic, preferably of semi-rigid silicone rubber, that allows it to fit closely to the rim 205 of opening 208 of container 201. A preferred lid 231 made of semi-rigid silicone rubber can also better enable the vertical slot opening 246 of the central collar 241 to grip the inserted stick 251 and allows a snuggly fitting of stick 251 into the slot opening 246.

FIG. 7 is a cross-sectional view of the removable lid member 231 of FIG. 6 showing the broad side view of the lid, taken along line 7-7 of FIG. 6, wherein the lid body 232 comprises edge 233, ridge 234, and central collar 241, wherein said central collar comprises the exterior portion 242 with opening 244, interior portion 243 with opening 245, and the longitudinal inner side 246 that defines the slot that holds the broad side of stick 251.

FIG. 8 is an overhead view of the container member 201 of the modular mold unit of FIG. 6 showing the round top side 204 comprising circular rim 205, outer edge 206, and inner edge 207, wherein said inner edge 207 delineates the opening 208 of cavity 209. The cavity 209 reveals the inner side 217 of the tapered circular cylindrical side 211 and the round inner side 218 of the round bottom side 212. FIG. 8 also shows the female mating connector members 223 and 224 male mating connector members 225 and 226 that are integrally molded to the top side 204 at points 213, 214, 215, and 216, respectively.

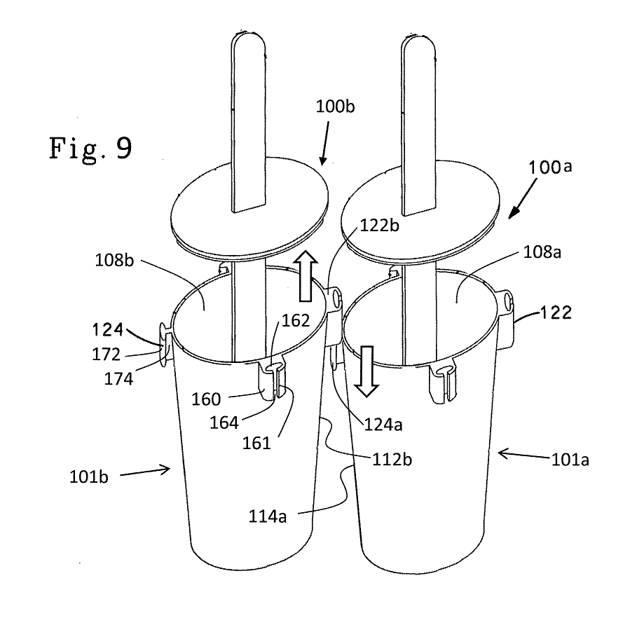

FIG. 9 shows a pair of modular mold units 100a and 100b. The container members 101a and 101b are connected through a vertical female coupling connector member 122b on the container member 101b, and a vertical male coupling connector member 124a on the container member 101a. As illustrated, the connection between the vertical female and vertical male coupling connectors is in the process of being unhooked or disconnected, with the container member 101b and its vertical female coupling connector member 122b being moved in an upward vertical direction (in the direction of the up arrow, normal to the opening 108b), and the container member 101a and its vertical male coupling connector member 124a being moved in a downward vertical direction (in the direction of the down arrow, normal to the opening 108a). The relative movements of the connectors being connected, or disconnected, is vertical (normal to the top opening 108), rather than lateral.

The vertical female coupling connector member 122 includes a vertically elongated channel 162 of substantially constant horizontal cross section, passing through the body of the connector, and a vertically elongated slot 164 communicated with the channel 162 to define confronting first arm 160 and second arm 161. The first arm 160 and second arm 161 encircle or surround the channel 162 along the opposed lateral sides. The vertical male coupling connector member 124 includes a vertically elongated head 172 of substantially constant horizontal cross section, which extends by a neck 174 from the body side aspect 114a of the container member 101a for registering the head 172 with a channel 162 in vertical female coupling connector member 122b of the adjacent container 101b. The vertically elongated head 172 is configured to slidingly enter and frictionally engage the elongated channel 162 of the vertical female coupling connector member 122, to allow hooking or connecting together (and unhooking or disconnecting) of the two container members by manual force, and a stable connection together of the container members that will not work itself loose or apart under ordinary handling. The lateral extensions of the head 172 are restrained by the first arm 160 and second arm 161 to prevent lateral movement and provide the frictional fit and engagement. The substantially constant horizontal cross section of the head 172 and the channel 162 allow entry of the head into either of the top opening of the bottom opening of the channel.

In the illustrated embodiment, the general sectional shape of the head portion and its counterpart channel portion are oval, although other shape/s can be employed, including circular, elliptical, rectanlinear, and polygonal. The height or length (vertically) of the male and female coupling connectors are generally greater than the maximum horizontal dimension of the head. Longer connector lengths improve the rigidity of the connection and of the assembled array of containers, while increasing the frictional engagement between the head and channel.

It can be understood that the respective containers can also be unhooked or disconnected by movement in the opposed vertical directions; that is, the container member 101b and its vertical female coupling connector member 122b being moved in a downward vertical direction and the container member 101a and its vertical male coupling connector member 124a being moved in an upward vertical direction. While only two container members 101 are shown, it can also be appreciated and understood that additional container members can be connected adjacent and surrounding either or both of container members 101a and 101b; and that any one, two or more connected container members can be moved vertically as a subunit, relative to the remaining container members surrounding and connected thereto. One or more container members can be removed from the middle of larger group or array of container members. This allows independent selection by the user of an individual container from the array, including a container surrounded by other containers, without disrupting or breaking the other connections between the other containers.

The above description discloses, by way of example, some typical embodiments of the present invention. However, persons of ordinary skill in the art are capable of creating numerous modifications within the scope of the claims. Changes in specifics of form and details can be made to the above-described embodiments. The claims and not the examples are the measure of the protected invention.

What is claimed is:

1. A modular mold unit for making frozen confection comprising a container member having a top opening on the top side, a removable and reclosable lid member covering the top opening, and four vertical coupling connector members disposed on an exterior side surface of the container member to firmly and removably connect a plurality of said modular mold units to one another to form an assembly of mold units, the four vertical coupling connector members comprising two vertical female connectors, and two vertical male connectors that operatively connect to the female coupling connector members by a vertical insertion, and wherein the container member is made of a plasticizer-free, unadulterated, and nonrecycled plastic material selected from the group consisting of high density polyethylene, low density polyethylene, polypropylene, polyethylene terephthalate, and mixtures thereof.

2. The modular mold unit of claim 1, wherein the removable and reclosable lid member fits snuggly over the top opening and is selected from the group consisting of (1) a first lid member comprising a lid body having a raised ridge, an exterior stick handle, and an interior stick anchor wherein said interior stick anchor and said exterior stick handle are integrally molded to said lid body, wherein the first lid member is made of a plasticizer-free, unadulterated, and nonrecycled plastic material selected from the group consisting of high density polyethylene, low density polyethylene, polypropylene, polyethylene terephthalate, and mixtures thereof; and (2) a second lid member comprising a lid body having a raised ridge and a central collar with a longitudinal slot that is centrally located in said second lid member and can frictionally hold and support a separate wooden or plastic stick at a position that divides the separate wooden or plastic stick into an exterior stick handle and an interior stick anchor.

3. The modular mold unit of claim 1, wherein said container member comprises a tapered ovoid cylindrical receptacle, the top opening is an oval top opening, the exterior side surface of the container member includes a tapered ovoid cylindrical side with two opposing broad side aspects and two opposing narrow side aspects, and an oval bottom side, the two vertical female connectors are integrally molded at an upper portion two adjacent aspects of the tapered ovoid cylindrical side, and the two vertical male connectors are integrally molded at an upper portion to the other two adjacent aspects of the tapered ovoid cylindrical side, and wherein said removable and reclosable lid member is oval.

4. The modular mold unit of claim 3, wherein said removable and reclosable lid member is the second lid member, and wherein said second lid member is made of semi-rigid silicone rubber or a plasticizer-free, unadulterated, and nonrecycled plastic material selected from the group consisting of high density polyethylene, low density polyethylene, polypropylene, polyethylene terephthalate, and mixtures thereof.

5. The modular mold unit of claim 1, wherein said container member comprises a tapered circular cylindrical receptacle, the top opening is a circular top opening, the exterior side surface of the container member includes a tapered circular cylindrical side, and a circular bottom side, the two vertical female connectors and the two vertical male connectors are consecutively and integrally molded at equidistance around an upper portion the tapered circular cylindrical side, with the two vertical female connectors adjacent to each other and the two vertical male connectors being adjacent to each other, and wherein said removable and reclosable lid member is circular.

6. The modular mold unit of claim 5, wherein said removable and reclosable lid member is the second lid member, and wherein said second lid member is made of semi-rigid silicone rubber or a plasticizer-free, unadulterated, and nonrecycled plastic material selected from the group consisting of high density polyethylene, low density polyethylene, polypropylene, polyethylene terephthalate, and mixtures thereof.

7. The mold assembly of claim 1 wherein said removable and reclosable lid is made of semi-rigid silicone rubber.

8. The mold assembly of claim 1 wherein the vertical female connectors have a vertically elongated channel of substantially constant horizontal cross section, and include a first arm and second arm surround the channel along opposed lateral sides of the channel to define a vertically elongated slot that communicates with the channel, and the vertical male connectors include a vertically elongated head of substantially constant horizontal cross section, which extends by a neck from the exterior side surface of the container member.

9. The mold assembly of claim 8 wherein the vertically elongated head is configured to slidingly enter and frictionally engage the elongated channel.

10. The mold assembly of claim 9 wherein the sectional shape of the head portion and its counterpart channel portion are oval.

11. An article of manufacture comprising a plurality of modular mold units according to claim 2, instructions for use, and optionally a plurality of wooden or plastic sticks, wherein said separate plastic stick is made of plasticizer-free, unadulterated, and nonrecycled plastic.

12. The article of claim 11 wherein the instructions for use indicate that: the molds can be used to save space in the freezer compartment; the molds can be safely used in a microwave oven for quickly, conveniently, and hygienically releasing the confections from the molds; and the way to determine the length of time to heat in a microwave oven; wherein said instructions for use are printed on one or more of: the package; the accompanying instruction flyer; and/or communicated via print and/or electronic mass media: newspapers, magazines, radio, television, internet, circulars, and the like, and wherein said instructions can be in words, or illustrative images and/or icons including in combination with words.

13. A method for production of frozen confections that allows the preparation of an exact number of frozen confections on a stick that are needed without causing extra dead space in a freezer compartment of a home refrigerator, and that allows a quick and convenient release of the frozen confections by a microwave oven, said method including the steps of:
(1) providing a plurality of modular mold units according to claim 1;
(2) connecting together a desired number of modular mold units to one another using the respective vertical female and vertical male coupling connector members to form an assembly of mold units;
(3) filling the container members of the mold units with liquid confection material;
(4) optionally snuggly fitting a lid over the openings of the container members;
(6) placing the assembly of filled mold units into a freezer and waiting until the liquid confection material is frozen;
(7) removing the assembly of mold units containing the frozen confections from the freezer, raising vertically a desired number of mold units containing the frozen confections for immediate consumption, to unhook the vertical male and female coupling connection member thereof from their associated vertical female and male coupling connection members of the unused mold units of the assembly, and setting aside the desired number of mold units containing the frozen confections for immediate consumption;
(8) returning the smaller assembly of unused mold units containing the frozen confections to the freezer compartment; and
(9) heating the frozen confections in the set-aside molds using a microwave oven to quickly and conveniently release the frozen confections from the molds.

14. The method according to claim 13 wherein the heating in the microwave oven is performed for a required heating time selected from the group consisting of at least about 2 seconds, at least about 4 seconds, at least about 5 seconds, up to about 20 seconds, up to about 15 seconds, up to about 10 seconds, and combinations thereof.
